(19) United States
(12) Patent Application Publication
(10) Pub. No.: US 2008/0238411 A1
(43) Pub. Date: Oct. 2, 2008

(54) Magneto-Resistive Nano-Particle Sensor

(75) Inventors: Josephus Arnoldus Henricus Maria Kahlman, Eindhoven (NL); Haris Duric, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/090,427

(22) PCT Filed: Oct. 16, 2006
(86) PCT No.: PCT/IB06/53793

§ 371 Date: Apr. 16, 2008

(30) Foreign Application Priority Data
Oct. 19, 2005 (EP) 05109737.6

(51) Int. Cl. G01N 27/74

(52) U.S. Cl. 324/204

(57) ABSTRACT

A magnetic sensor device is suggested. The magnetic sensor device comprises at least one magnetic field generator, a magnetic sensor element (8), means (17) for supplying a frequency modulated sense current to the magnetic sensor element (8). A rejection means (18) is arranged in the signal path between the magnetic sensor element (8) and an amplifier (11). The rejection means (18) is apt for rejecting a signal component at the modulation frequency. The rejection means (18) allows reducing the required dynamic range of the amplifier (11) significantly because a large part of the sensed signal carrying no measurement information is not transmitted to the amplifier (11).

The present invention is related to a magnetic sensor device. In particular, the invention is related to a magneto-resistive nano-particle sensor having sensor elements, which are arranged in arrays. Devices of this type are also called micro-arrays or biochips.

### BACKGROUND OF THE INVENTION

The introduction of micro-arrays or biochips is revolutionizing the analysis of samples for DNA (desoxyribonucleic acid), RNA (ribonucleic acid), proteins, cells and cell fragments, tissue elements, etc. Applications are e.g. human genotyping (e.g. in hospitals or by individual doctors or nurses), bacteriological screening, biological and pharmacological research.

Biochips, also called biosensor chips, biological microchips, gene-chips or DNA chips, consist in their simplest form of a substrate on which a large number of different probe molecules are attached, on well defined regions on the chip, to which molecules or molecule fragments that are to be analyzed can bind if they are perfectly matched. For example, a fragment of a DNA molecule binds to one unique complementary DNA (c-DNA) molecular fragment. The occurrence of a binding reaction can be detected, e.g. by using fluorescent markers that are coupled to the molecules to be analyzed. This provides the ability to analyze small amounts of a large number of different molecules or molecular fragments in parallel, in a short time. One biochip can hold assays for 10-1000 or more different molecular fragments. It is expected that the usefulness of information that can become available from the use of biochips will increase rapidly during the coming decade, as a result of projects such as the Human Genome Project, and follow-up studies on the functions of genes and proteins.

In WO 2005/010543A1 such a magnetic sensor device or biosensor is described. The biosensor detects magnetic particles in a sample such as a fluid, a liquid, a gas, a visco-elastic medium, a gel or a tissue sample. The magnetic particles can have small dimensions. With nano-particles are meant particles having at least one dimension ranging between 0.1 nm and 1000 nm, preferably between 3 nm and 500 nm, more preferred between 10 nm and 300 nm. The magnetic particles can acquire a magnetic moment due to an applied magnetic field (e.g. they can be paramagnetic) or they can have a permanent magnetic moment. The magnetic particles can be a composite, e.g. consist of one or more small magnetic particles inside or attached to a non-magnetic material. The particles can be used as long as they generate a non-zero response to the frequency of an ac magnetic field, i.e. e. when they generate a magnetic susceptibility or permeability.

In the known sensor device a current wire generates a magnetic field at frequency f₁ for magnetization of super paramagnetic beads (nano-particles) near a GMR sensor. The stray field from these beads is detected in the GMR sensor and generates a signal indicative of the number of beads present near the sensor.

However, due to parasitic capacitance between the current wires and the GMR sensor a strong capacitive cross-talk signal at the bead excitation frequency f₁ appears at the output of the amplifier A₁. This signal interferes with the magnetic signal from the beads.

The capacitive cross-talk between field generating means and the magneto resistive sensors can be suppressed by modulating the sense current of the sensor. This measure separates the capacitive cross talk and the desired magnetic signal in the frequency domain.

The GMR sensor signal is supplied to an amplifier, which is required to have a very large dynamic range e.g. 120 dB. Since the number of magnetic beads is proportional to the signal of the GMR sensor, the amplifier has to be linear across the complete dynamic range. Any non-linearity will severely disturb the measurement result.

### SUMMARY OF THE INVENTION

It is therefore an object of the present invention to provide a magneto-resistive sensor that imposes less demanding performance requirements on the components forming the sensor.

The object is solved by a magnetic sensor device according to claim 1. In particular, the invention suggests a magnetic sensor device comprising at least one magnetic field generator, a magnetic sensor element, means for supplying a frequency modulated sense current (iₛₑₙₛₑ) to the magnetic sensor element. A rejection means is arranged in the signal path between the magnetic sensor element and an amplifier. The rejection means is apt for rejecting a signal component at the modulation frequency. The rejection means allows to reduce the required dynamic range of the amplifier significantly because a large part of the sensed signal carrying no measurement information is not transmitted to the amplifier. In an advantageous embodiment of the invention the magnetic sensor element is a GMR (Giant Magnetic Resistance), TMR (Tunnel Magneto Resistance), or an AMR (Anisotropic Magneto Resistance) sensor element providing a high sensitivity. In a further development of the invention the magnetic sensor element is formed by a differential GMR sensor element, which is even more sensitive. Moreover, the magnetic sensor element can be any suitable sensor element based on the detection of the magnetic properties of particles to be measured on or near to the sensor surface. Therefore, the magnetic sensor is designable as a coil, magneto-resistive sensor, magneto-restrictive sensor, Hall sensor, planar Hall sensor, flux gate sensor, SQUID (Semiconductor Superconducting Quantum Interference Device), magnetic resonance sensor, or as another sensor actuated by a magnetic field.

In a preferred embodiment of the invention the rejection means are filter means rejecting the signal component of the magnetic sensor element being modulated at the modulation frequency. In this case the filter means can include a high-pass or band-pass filter.

In another preferred embodiment of the invention the rejection means are formed by a common-mode amplifier rejecting the signal component of the magnetic sensor element being modulated at the modulation frequency.

For certain applications it can also be advantageous to provide the rejection means as a combination of the filter means and the common-mode amplifier mentioned above in relation to preferred embodiments.

In a preferred embodiment of the invention a plurality of sensor elements are arranged in an array.

### BRIEF DESCRIPTION OF THE DRAWINGS

The invention will be better understood and other particular features and advantages will become apparent on reading the following description appended with Figures. In the Figures similar elements or components will be designated with the same reference numbers. It shows:

FIG. 1 a magneto-resistive sensor device known in the prior art;

FIG. 2 the relative magnitude of the spectral components of the sensor signal shown in FIG. 1;

FIG. 3 a first embodiment of the magneto-resistive sensor device according to the invention;

FIG. 4 a high-pass filter of the magneto-resistive sensor device shown in FIG. 3;

FIG. 5 a second embodiment of the magneto-resistive sensor device according to the invention; and

FIG. 6 a third embodiment of the magneto-resistive sensor device according to the invention.

### DETAILED DESCRIPTION OF PREFERRED EMBODIMENTS

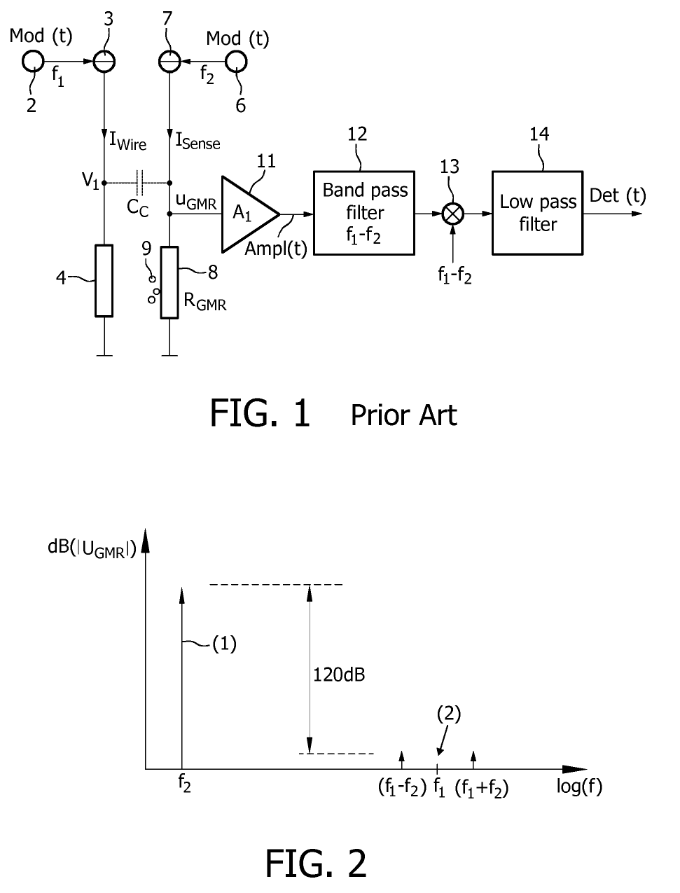

FIG. 1 shows a magneto-resistive sensor device known in the prior art. A first modulator 2 modulates a first current source 3 at a frequency f₁. The first current source 3 supplies a current i_{wire} to a conductor 4 generating a magnetic field at the frequency f₁ for magnetization of magnetic nano-particles, e.g. super-paramagnetic beads. The frequency f₁ is chosen to not cause a substantial movement of the magnetic nano-particles, e.g. 50 kHz. A second modulator 6 modulates a second current source 7 at a frequency f₂. The second current source 7 supplies a sinusoidal sense current iₛₑₙₛₑ to a GMR (Giant Magnetic Resistance) sensor 8. The GMR sensor 8 generates an output signal u_{GMR} as a function of the number of magnetic nano-particles in the vicinity of the GMR sensor 8. The magnetic nano-particles are shown in FIG. 1 as bubbles 9. Depending on the presence of nano-particles 9 in the neighborhood of the magneto-resistive sensor 8, the magnetic field at the location of the sensor 8, and thus the resistance of the sensor 8 is changed. Capacitive cross-talk between the conductor and the magneto-resistive sensor 8 is symbolized by a coupling capacitor C_{c} indicated with dotted lines in FIG. 1.

Without the presence of magnetic particles, the input signal is the alternating magnetic field from the conductor. Depending on the presence of nano-particles 9 in the neighborhood of the magneto-resistive sensor 8, the magnetic field at the location of the sensor 8, and thus the resistance of the sensor 8 is changed. A different resistance of the sensor 8 leads to a different voltage drop over the sensor 8, and thus to a different measurement signal delivered by the sensor 8. The resulting output signal of the GMR sensor is a continuous wave. The measurement signal delivered by the magneto-resistive sensor 8 is then delivered to an amplifier 11 for amplification thus generating an amplified signal Ampl (t). The amplified signal Ampl (t) is detected, synchronously demodulated by passing through a demodulating multiplier 13 where the signal is multiplied with a modulation signal at a frequency f₁-f₂. In a last step, the intermediate signal is sent through a low pass filter 14. The resulting signal Det (t) is then proportional to the number of magnetic nano-particles 9 present at the surface of the sensor 8.

The sensor shown in FIG. 1 exhibits the problem that by modulating the sense current, the voltage component at the modulation frequency can easily overdrive the preamplifier stage.

This is explained further in the following: The total resistance of the GMR may be modeled as a series connection of two separate contributions, a static resistance R and dynamic resistance ΔR.

R_{GMR}=R+ΔR

The static resistance R is constant and contains no information of interest. The dynamic resistance ΔR is frequency dependent and indicative for the amount of nano-particles near the sensor.

ΔR=\hat{r} sin(ω₁t)

The voltage across the GMR strip (u_{GMR}), which is supplied to the first amplifier A₁, is equal to the product of the sense current and GMR resistance,

u_{GMR}=iₛₑₙₛₑ·R_{GMR}

which can be further dissolved into the following components,

$$\begin{matrix}{u}_{GMR} = {\hat{i}}_{sense} sin ( {ω}_{2} t ) \cdot ( R + \hat{r} sin ( {ω}_{1} t ) ) \\ = \underbrace{R {\hat{i}}_{sense} sin ( {ω}_{2} t )}_{1} + \underbrace{\frac{{\hat{i}}_{sense} \hat{r}}{2} ( sin ( ( {ω}_{1} + {ω}_{2} ) t ) + sin ( ( {ω}_{1} - {ω}_{2} ) t ) )}_{2}\end{matrix}$$

Component (1) may be regarded as unwanted interference and component (2) represents the magnetic signal voltage, which contains the desired magnetic signal from the beads. Both components are proportional to the sense-current magnitude îₛₑₙₛₑ.

It is preferable to maximize the signal voltage (2) that is being observed by the amplifier A₁, which can be achieved by maximizing the magnitude of the sense current îₛₑₙₛₑ. However, maximizing the magnitude of the sense current îₛₑₙₛₑ also maximizes the unwanted interference component (1).

The practical limitation for the magnitude of the sense current is determined by power dissipation constraints, which are set by the available thermal budget. The maximum temperature of the biological material on top of the sensor is limited to 38° C. For standard sensor geometries the maximum value of the sense current is in the order of 1 to 3 mA.

Component (1): Magnitude of the Static Sense Current Component at f₂

For the nominal GMR sensor resistance R=560Ω and the sense current îₛₑₙₛₑ=2 mA the magnitude of the static component (a) across the sensor is 1.12 V.

û_{GMR,static}≈1.12 V

Component (2): Magnitude of the Desired Voltage Signal at (f₁−f₂) and (f₁+f₂)

The typical magnitude of the desired signal voltage (2) originating from the beads is in the order of several μV.

û_{GMR,signal}≈1-20 μV

FIG. 2 illustrates the relative magnitude of said spectral components. The static component (1) is six orders of magnitude larger than the desired signal voltage (2), so that component (1) can easily saturate the sensitive amplifier A₁. To accommodate for this, the amplifier A₁ needs to have a large dynamic range. In the present example a dynamic range of 120 dB is required.

Usually the required linearity can only be achieved by extra circuit measures, e.g. resistive degeneration. This is undesirable since it reduces the gain and thereby also the noise performance of the circuit. Furthermore it increases the dissipation of the amplifier, which limits the thermal budget of the biosensor.

However, if the dynamic range performance is not met, the circuit will generate distortion components that will severely disturb the actual measurement.

For both reasons, it is preferable not to depend on the high dynamic range of the first amplifier A₁.

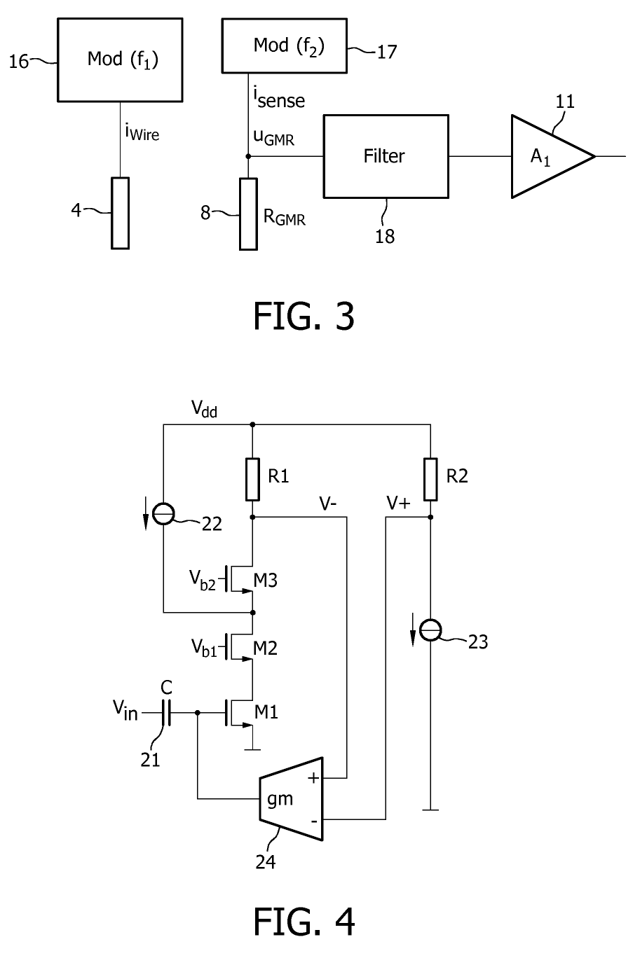

In FIG. 3 a first embodiment of the magneto-resistive sensor device according to the invention is shown. The sensor device comprises a current source 16 supplying a modulated wire current i_{wire} to a magnetic field generating conductor 4. The wire current i_{wire} is modulated with frequency f₁. A current source 17 supplies the GMR sensor 8 with a sense current iₛₑₙₛₑ modulated at frequency f₂. The sensor voltage u_{GMR} is supplied to a high pass filter 18, the output of which is connected to the input of amplifier 11. The filter 18 is designed to reject the signal component at the sense current modulation frequency f₂. The rejection can be achieved by filtering in the frequency domain.

Thus the need for a large dynamic range of the preamplifier can be eliminated.

Preferably the ratio

$$\frac{{f}_{1}}{{f}_{2}}$$

is chosen large to maximize the attenuation per filter order, which is important for IC integration.

The filter is preferably integrated on the amplifier IC and is preferably a low-order filter (1^{st} or 2^{nd} order), since high-order integrated filters are difficult and noisy.

For the case that the filter high-pass corner frequency (f_{-3dB}) is chosen equal to f₁, the suppression at the sense-current frequency f₂ can be approximated by

$${H}_{suppres} = N \cdot 20 log ( \frac{{f}_{1}}{{f}_{2}} ) dB$$

where N is the filter order.

The above equation shows that the suppression can be increased either by increasing the order of the filter N, and/or by increasing the frequency separation between the magnetic field frequency f₁ and the sense-current frequency f₂ (the ratio f₁/f₂).

For a given suppression it is preferable to increase the frequency separation to facilitate that a low-order filter can be used.

The amplifier 11 with a high-pass filter 18 can be implemented in a CMOS IC as shown in FIG. 4. The output signal of GMR sensor 8 is supplied as a voltage Vᵢₙ to the filter 18. The voltage signal Vᵢₙ is coupled by a capacitor 21 to the gate of a field effect transistor M1, which is arranged in a serial source-drain configuration with two further field effect transistors M2 and M3. A first current source 22 generates a bias voltage V_{dd} to the drain of transistor M3 via a resistor R1. The other output of the current source 22 is connected between the source of transistor M3 and the drain of transistor M2. A voltage V− is tapped at the drain of transistor M3 and provided to the non-inverting input of differential amplifier 23. The bias voltage V_{dd} is also supplied to a parallel resistor R2 the second contact of which is connected to a second voltage source 22. A reference voltage V+ is tapped between the resistor R2 and the current source 22, and the reference voltage V+ is supplied to the inverting input of the differential amplifier 23.

The output signal of differential amplifier 23 is connected to the gate of transistor M1.

The above circuit exhibits a 1^{st} order high-pass transfer with −3 dB corner frequency given by

$${f}_{- 3 dB} = \frac{Av \cdot gm}{2 π C}$$

where Av (=g_{m,M1}·R1) is the voltage gain from the gate of M1 to V−.

A high-pass corner of e.g. f_{-3dB}=10 MHz with an AC coupling capacitance C=100 pF can be achieved by e.g. the voltage gain Av=100 (40 dB) and gm=63 μS.

It is noted that the capacitance value could be made smaller to reduce the chip area. However, how small the capacitance C can be made is constrained by the capacitive attenuation caused by C and the parasitic capacitance of M1. This attenuation should be kept small, in order not to degrade the gain and thereby the noise performance. The circuit arrangement shown in FIG. 4 has the additional advantage that all low-frequent disturbances and 1/f noise originating from the GMR sensor and sense-current circuitry are also suppressed.

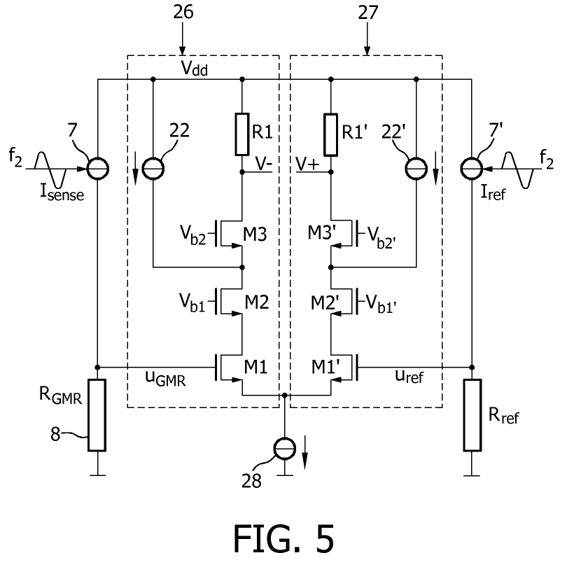

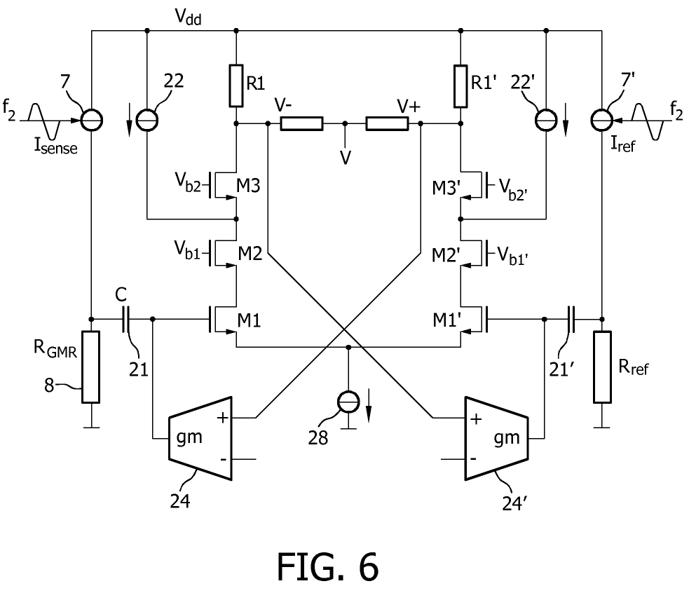

In FIG. 5 a balanced amplifier is shown. FIG. 5 shows a CMOS IC implementation of the circuit arrangement. The interference component (1) at frequency f₂ is applied in common mode making the amplifier insensitive to the interference. Basically the amplifier of FIG. 4 is mirrored to create two amplifier portions 26, 27. The amplifier portion 26 shown on the left hand side in FIG. 5 is supplied with the sensor signal u_{GMR} of sensor 8, whereas the amplifier portion 27 shown on the right hand side of FIG. 5 is supplied with a reference signal u_{ref} generated by a reference resistor R_{ref}. A common constant current source 26 in connected to both amplifier portions 26, 27. The reference resistor R_{ref} is provided with a reference current i_{ref} also modulated with the same frequently f₂ as the sense current iₛₑₙₛₑ.

The circuit is preferably fully symmetrical for maximum common-mode rejection.

The magnitude of the reference current i_{ref} and the resistance value of resistor R_{ref} can be scaled such that in the static situation the voltage u_{ref} is substantially equal to u_{gmr}. The scaling can be made fixed and/or adjustable to compensate for possible imbalance (by e.g. tuning the value of i_{ref} or R_{ref}).

In another embodiment, the resistance R_{ref} can be replaced by a second GMR strip substantially equal to the first GMR strip, which produces the opposite signal for the same magnetic field. Such an arrangement is called a differential GMR sensor providing a higher sensitivity as single GMR sensor.

The circuit arrangement shown in FIG. 5 and its variations described allow for DC coupling of the amplifier and the sensor, which avoids IC area consuming coupling capacitors. Reducing the necessary IC area for the implementations of the sensor arrangement is cost efficient.

Finally, FIG. 6 illustrates a combination of the circuit arrangements shown in FIGS. 4 and 5. The circuit of FIG. 6 combines the filtering and common-mode rejection properties of the embodiments described above. Corresponding components are referenced with like reference symbols. The rejection of the interference component (1) at frequency f₂ is improved by the combination of the filtering and common-mode rejection mechanisms. FIG. 6 exhibits a CMOS IC implementation of the circuit. Again, also in this embodiment the reference resistor R_{Ref} could be replaced be a second GMR sensor to form a differential GMR sensor to enhance the sensitivity. The advantages of this embodiment are a low noise degradation of the output signal and a low power consumption due to small currents and small voltages. Finally, it is noted that the described circuit arrangement can easily integrated in an IC.

The magnetic sensor device is described by example of a in the foregoing sensor can be any suitable sensor to detect the presence of magnetic particles on or near to a sensor surface, based on any property of the particles, e.g. it can detect via magnetic methods, e.g. magnetoresistive, Hall, coils. The sensor can detect via optical methods, for example imaging, fluorescence, chemiluminescence, absorption, scattering, surface plasmon resonance, Raman spectroscopy etc. Further, the sensor can detect via sonic detection, for example surface acoustic wave, bulk acoustic wave, cantilever deflections influenced by the biochemical binding process, quartz crystal etc. Further, the sensor can detect via electrical detection, for example conduction, impedance, amperometric, redox cycling, etc.

1. A magnetic sensor device comprising at least one magnetic field generator, a magnetic sensor element, means for supplying a frequency modulated sense current (iₛₑₙₛₑ) to the magnetic sensor element, wherein the sense current is modulated at a frequency (f₂), wherein a rejection means is arranged in the signal path between the magnetic sensor element and an amplifier, wherein the rejection means is configured to reject a signal component at the modulation frequency (f₂).

2. The magnetic sensor device of claim 1, wherein the magnetic sensor element is a GMR, TMR (Tunnel Magneto Resistance), or an AMR (Anisotropic Magneto Resistance) sensor element.

3. The magnetic sensor device of claim 1, wherein the magnetic sensor element is formed by a differential GMR sensor element.

4. The magnetic sensor device of claim 1, wherein the rejection means are filter means rejecting the signal component of the magnetic sensor element being modulated at the modulation frequency (f₂).

5. The magnetic sensor device of claim 1, wherein the rejection means are filter means and the filter means include a high-pass or band-pass filter.

6. The magnetic sensor device of claim 1, wherein the rejection means are formed by a common-mode amplifier rejecting the signal component of the magnetic sensor element being modulated at the modulation frequency (f₂).

7. The magnetic sensor device of claim 1, wherein the rejection means are filter means rejecting the signal component of the magnetic sensor element being modulated at the modulation frequency (f₂), the filter means include a high-pass or band-pass filter, and the rejection means are a combination of the filter means and common-mode amplifier rejecting the signal component of the magnetic sensor element being modulated at the modulation frequency (f₂).

8. The magnetic sensor device of claim 1, wherein a plurality of sensor elements (8) are arranged in an array.

9. The magnetic sensor device of claim 1, wherein the magnetic sensor device comprises an optical detection means, especially for optical detection of magnetic particles.
